(19) United States
(12) Patent Application Publication
(10) Pub. No.: US 2007/0182879 A1
(43) Pub. Date: Aug. 9, 2007

(54) Liquid crystal display device and light source device applicable to the same

(76) Inventor: Yukio Ooami, Hyogo-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/700,108

(22) Filed: Jan. 31, 2007

(30) Foreign Application Priority Data
Feb. 2, 2006 (JP) P2006-026202

(51) Int. Cl. G02F 1/1333

(52) U.S. Cl. 349/60

(57) ABSTRACT

LCD device 10 is prevented from display unevenness caused by thermal expansion of polarlizers 16 due to heat from lamp 28. Light scattering dotted patterns are formed on a surface of light guide member 18. The light scattering dotted patterns include dense dot region 32 containing large dots 30 and sparse dot regions 36 containing small dots 34. Sparse dot region 36 is defined by an imaginary arch-like boundary line extending from lower left corner portion 38 of light guide member 18 to its lower right corner portion 40 and a lower side of light guide member 18.

### CROSS-REFERENCE OF RELATED APPLICATIONS

This application is based upon and claims the benefit of priority from the prior Japanese Patent Application No. 2006-26202, filed on Feb. 2, 2006, the entire contents of which are incorporated herein by reference.

### FIELD OF THE INVENTION

This invention generally relates to a liquid crystal display device provided with a liquid crystal cell unit and a polarlizer set on the liquid crystal cell unit, and to a light source device applicable to such a liquid crystal display device.

### BACKGROUND OF THE INVENTION

A liquid crystal display (LCD) device includes a liquid crystal (LC) cell unit and a rear light source device to illuminate the LC cell unit. The rear light source device is provided on the back side of the LC cell unit to illuminate it. The rear light source device has a light guide member, a lamp set on a side portion of the light guide member and a reflector disposed on the back side of the light guide member. In order for the lamp to uniformly irradiate light onto the LC cell unit, a dotted pattern is formed on the back of the light guide member (as disclosed in Japanese Patent Publication 2003-131040 and Japanese Patent Publication 2000-221329, for instance).

When the LCD device is continuously driven or operates at a high temperature, display unevenness occurs on upper and lower areas of the LC cell unit as shown in FIG. 3. More particularly, as shown in FIG. 3, LC cell unit 100 may have displaying (white) unevenness take place at lower region 108 defined between unclearly bounded imaginary arch-like line 106 extending from lower left corner portion 102 to lower right corner portion 104 and the lower side. Likewise, display unevenness may also take place at upper region 112 defined between unclearly bounded imaginary arch line 110 and the upper side. Such display unevenness is primarily caused by mutual displacement of the absorptive axes of polarizers provided on both front and rear surfaces of LC cell unit 100 resulting from thermal expansion of the polarizers. Such displacement of the absorption axes makes light pass through the absorption axes, so that display unevenness appears significantly on a black image display. That is, the areas through which the light passes appear to be unevenly white.

Such light passing-through phenomena are significantly seen on the long sides of a laterally long screen size (16:9) LC cell unit that has been recently available on the market. When a rear light source device starts turning on, display unevenness takes place slightly. However, when the rear light source device is continuously driven, heat from its lamp makes the display unevenness worse. Especially, since a side light type rear light source device has a lamp provided along a circumference of an LCD device and its counterpart circumference of an LC cell unit is affected by heat from the lamp, temperature difference occurs between central and circumferential portions of the LC cell unit, so that thermal expanding difference of polarizers causes such display unevenness as shown in FIG. 3.

The following four counter measures have been carried out for the above-mentioned display unevenness.

The first counter measure is that the polarizers are made from heat-resistance materials. The second countermeasure is the reduction of an electric current flowing through the lamp to prevent heat of the rear light source device itself from rising-up. The third countermeasure is the insertion of a heat insulating sheet between the rear light source device and the LC cell unit to stop transferring heat from the rear light source device to the LC cell unit. The fourth countermeasure is that a heat conductive sheet is provided inside of the rear light source device to make temperature distributions uniform on the light projecting surface of the rear light source device.

The first countermeasure is difficult to improve the heat resistance because materials of polarizer themselves are resins. The reduction of an electric current flowing through the lamp of the second countermeasure does not only result in a subtle heat reduction effect but also creates a problem for the lamp ability to lower its brightness. According to the third countermeasure, even though the heat insulating sheet is inserted in a compact housing of the LCD device, the sheet is thin so that its heat insulating effect is slight. The fourth countermeasure gives rise to a problem worsening in starting-up characteristics of the lamp (starting-up characteristics of brightness) because the lamp is prevented from rising itself to temperature.

### SUMMARY OF THE INVENTION

Accordingly, it is an object of the present invention to provide an LCD device that can solve such technical problems as set forth above and that can prevent display unevenness caused by thermal expansion of polarizers due to heat from a lamp.

An aspect of the present invention is directed to an LCD device provided with an LC cell unit, a polarizer attached to the LC cell unit, a light guide member having a surface on which dense and sparse dot regions are formed as light scattering dotted patterns, a reflective sheet provided on a back side of the light guide member, a lamp provided along a side of the light guide member, and a reflector to reflect light emitted from the lamp to the light guide member. Such an LCD device is featured in that the sparse dot region is defined by an imaginary arch-like boundary line extending from one corner portion of the light guide member to the other.

Another aspect of the present invention is directed to an LCD device provided with an LC cell unit, a polarizer attached to the LC cell unit, a light guide member having a surface on which large and small dot regions are formed as light scattering dotted patterns, a reflective sheet provided on a back side of the light guide member, a lamp provided at a side of the light guide member, and a reflector to reflect light emitted from the lamp to the light guide member. This LCD device is featured in that the sparse dot region is defined by an imaginary arch-like boundary line extending from one corner portion of the light guide member to the other.

A further aspect of the present invention is directed to a light source device provided with a light guide member having a surface on which dense and sparse dot regions are formed as light scattering dotted patterns, the sparse dot region being defined by an imaginary arch-like boundary line extending from a corner portion of the light guide member to another corner portion thereof and a side of the light guide member, a reflective sheet provided on a back side of the light guide member, a lamp provided at a side of the light guide member, and a reflector to reflect light emitted from the lamp to the light guide member. Such a light source device is featured in that the sparse dot region is defined by an imaginary arch-like boundary line extending from one corner portion of the light guide member to the other. The light source device is applicable to an LCD device.

A yet further aspect of the present invention is directed to a light source device provided with a light guide member having a surface on which large and small dot regions are formed as light scattering dotted patterns, a reflective sheet provided on a back side of the light guide member, a lamp provided at a side of the light guide member, and a reflector to reflect light emitted from the lamp to the light guide member. This light source device is featured in that the small dot region is defined by an imaginary arch-like boundary line extending from one corner portion of the light guide member to the other. The light source device is also applicable to an LCD device.

According to the present invention, since portions corresponding to any possible occurrence of display unevenness are substantially different in brightness from each other, display unevenness can be effectively prevented.

### BRIEF DESCRIPTION OF THE DRAWINGS

A more complete appreciation of the present invention and many of its attendant advantages will be readily obtained as the same becomes better understood by reference to the following detailed descriptions when considered in connection with the accompanying drawings, wherein:

FIG. 1 is a sectional view of an LCD device in accordance with an embodiment of the present invention;

FIG. 2 is a schematic plan view of the LCD device with a partially magnified layout of dotted patterns; and

FIG. 3 is a schematic plan view of a prior art LCD device.

### DETAILED DESCRIPTION OF THE INVENTION

Embodiments of the present invention will be explained below with reference to the attached drawings. It should be noted that the present invention is not limited to the embodiments but covers their equivalents. Throughout the attached drawings, similar or same reference numerals show similar, equivalent or same components. The drawings, however, are shown schematically for the purpose of explanation so that their components are not necessarily the same in shape or dimension as actual ones. In other words, concrete shapes or dimensions of the components should be considered as described in these specifications, not in view of the ones shown in the drawings. Further, some components shown in the drawings may be different in dimension or ratio from each other.

### EMBODIMENT

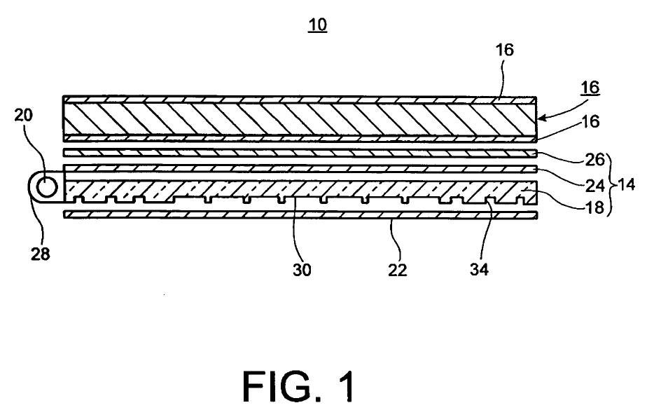

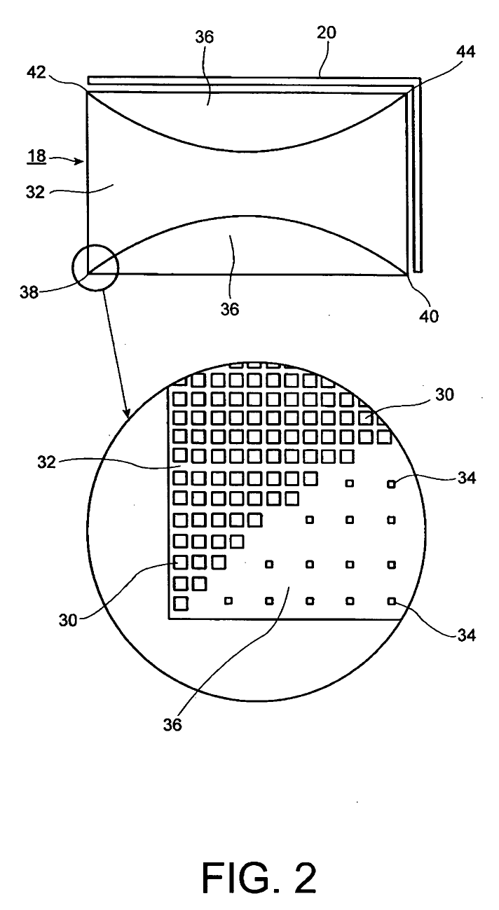

LCD device 10 in accordance with an embodiment of the present invention will be described below with reference to FIGS. 1 and 2.

The structure of LCD device 10 will be explained with reference to FIG. 1.

LCD device 10 includes LC cell unit 12 and rear light source device 14. Both LC cell unit 12 and rear light source device 14 are integrally contained in a bezel cover not shown.

LCD cell unit 12 is a laterally long screen size. Polarizers 16 are attached to the front and back surfaces of LCD cell unit 12. The “front surface of an LC cell unit” in this specification means an image displaying side surface of the LC cell unit while the “back surface” means the surface reverse to the front surface of the LC cell unit.

Rear light source device 14 is provided with light guide member 18, lamp 20 disposed along long and short sides of light guide member 18, reflective plate 22 set on the back side of light guide member 18, light diffusing plate 24 set in front of light guide member 18, and prism sheet 26 set on the front side of light diffusing plate 24. The “front surface of a light guide member” means a light projecting surface opposite to the back surface of the LC cell unit while the “back surface” means the surface reverse to the front surface of the light guide member. Lamp 20 is a straight type cold-cathode fluorescent tube with a character L configuration as shown in FIG. 2. Lamp 20 is disposed along long and short sides of LC cell unit 12. Further, lamp 20 is covered with reflector 28.

Next, the structure of light guide member 18 will be described below with reference to FIGS. 1 and 2.

Light guide member 18 has a flat surface on the front surface side but light scattering dotted patterns are formed on the back surface side of light guide member 18. The scattering dotted patterns are formed in dense and sparse dot regions 32 and 36. Large dots are densely formed in dense dot region 32 while small dots are sparsely formed in sparse dot regions 36. Both large and small dots are rectangular in plan view shape and concave in sectional view. As far as the dotted patterns scatter or diffuse light, the same may be of any plain view shapes, not only limited to rectangles, but also circles, ellipses and polygons. Further, large and small dots 30 and 34 are concave by way of example but they may be convex in sectional view.

As shown in FIG. 2, lower sparse dot region 36 is defined by an imaginary arch-like boundary line extending from lower left corner portion 38 of light guide member 18 to lower right corner portion 40 as a boundary and a lower side also extending from lower left corner portion 38 of light guide member 18 to lower right corner portion 40. Upper sparse dot region 36 is defined by an imaginary arch-like boundary line extending from upper left corner portion 42 of light guide member 18 to upper right corner portion 44 as a boundary and an upper side also extending from upper left corner portion 42 of light guide member 18 to upper right corner portion 44. Dense dot region 32 is formed between two sparse dot regions 36.

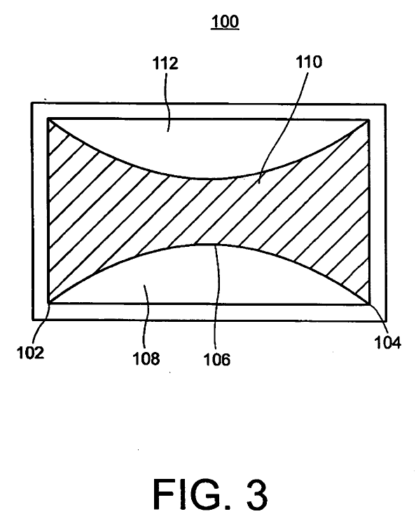

In LCD device 10 with light guide member 18, images in sparse dot regions 36 are less bright and those in dense dot region 32 is brighter. Thus, even when lamp 20 of rear light source device 14 generates heat, polarizers 16 expand and the absorptive axes of polarizers 16 are shifted so that light passes through the absorptive axes, sparse dot regions 36 corresponding to the portions where the light passes make its brightness less than dense dot region 32 does and reduce such display unevenness as shown in FIG. 3.

When the light scattering dotted patterns of light guide member 18 are designed, brightness distribution data of LC cell unit 12 are measured in advance. Shapes and layouts of large dots 30 and small dots 34 are determined based on the brightness data in respective areas of LC cell unit 12. Since the display unevenness remarkably appears on black images, when the shapes and layouts of the dotted patterns are directly designed to eliminate the display unevenness from black images, such design possibly causes display unevenness on white images. Thus, the layout of dense dot region 32 and sparse dot region 36 is determined with reference to an intermediate level between the unevenness on black images and that on white images.

The present invention is not limited to the embodiment described above but is applicable to various other embodiments without departing from its technical concept.

Sparse dot regions 36 are provided on the upper and lower long sides of light guide member 18 in the embodiment described above. Display unevenness can also take place, however, along the short sides. Heat causes the short sides of polarizers 6 to shrink. Thus, arch-like sparse dot regions 36 may be formed on the short sides.

Although large dots 30 and small dots 34 are formed on sparse dot regions 36 and dense dot region 32 as light scattering dotted patterns, dot sizes can be changed while their dot-lay-out density remains unchanged. Alternatively, the dot-lay-out density can be changed while a same dot size can be formed for sparse dot regions 36 and dense dot region 32.

Character L type lamp 20 is used for the embodiment described above. One character I type lamp, however, can be provided for each short side of light guide member 18 or two character I type opposite lamps may be substituted for character L type lamp 20.

Two kinds of large and small dots 30 and 34 are used for the description of the embodiment set forth above. Since the border line of the display unevenness is not clear, dotted patterns may be formed in accordance with a plurality of different size dots that are gradually laid out from the smaller dots through the larger dots.

In the foregoing description, certain terms have been used for brevity, clearness and understanding, but no unnecessary limitations are to be implied therefrom beyond the requirements of the prior art, because such words are used for descriptive purposes herein and are intended to be broadly construed. Moreover, the embodiments of the improved construction illustrated and described herein are by way of example, and the scope of the invention is not limited to the exact details of construction. Having now described the invention, the construction, the operation and use of embodiments thereof, and the advantageous new and useful results obtained thereby, the new and useful construction, and reasonable equivalents thereof obvious to those skilled in the art, are set forth in the appended claims.

What is claimed is:

1. A liquid crystal display device comprising:
a liquid crystal cell unit;
a polarizer attached to the liquid crystal cell unit;
a light guide member having a surface on which dense and sparse dot regions are formed as light scattering dotted patterns, the sparse dot region being defined by an imaginary arch-like boundary line extending from a corner portion of the light guide member to another corner portion thereof and a side of the light guide member;
a reflective sheet provided on a back side of the light guide member;
a lamp provided along a side of the light guide member; and
a reflector to reflect light emitted from the lamp to the light guide member.

2. A liquid crystal display device according to claim 1, wherein the sparse dot region is formed on a long side of the light guide member.

3. A liquid crystal display device according to claim 1, wherein the sparse dot region is formed on a short side of the light guide member.

4. A liquid crystal display device comprising:
a liquid crystal cell unit;
a polarizer attached to the liquid crystal cell unit;
a light guide member having a surface on which large and small dot regions are formed as light scattering dotted patterns, the sparse dot region being defined by an imaginary arch-like boundary line extending from a corner portion of the light guide member to another corner portion thereof and a side of the light guide member;
a reflective sheet provided on a back side of the light guide member;
a lamp provided at a side of the light guide member; and
a reflector to reflect light emitted from the lamp to the light guide member.

5. A liquid crystal display device according to claim 4, wherein the small dot region is formed on a long side of the light guide member.

6. A liquid crystal display device according to claim 4, wherein the small dot region is formed on a short side of the light guide member.

7. A light source device applicable to a liquid crystal display device, comprising:
a light guide member having a surface on which dense and sparse dot regions are formed as light scattering dotted patterns, the sparse dot region being defined by an imaginary arch-like boundary line extending from a corner portion of the light guide member to another corner portion thereof and a side of the light guide member;
a reflective sheet provided on a back side of the light guide member;
a lamp provided at a side of the light guide member; and
a reflector to reflect light emitted from the lamp to the light guide member.

8. A light source device according to claim 7, wherein the sparse dot region is formed on a long side of the light guide member.

9. A light source device according to claim 7, wherein the sparse dot region is formed on a short side of the light guide member.

10. A light source device according to claim 7, wherein the lamp is a cold-cathode fluorescent tube.

11. A light source device applicable to a liquid crystal display device, comprising:
a light guide member having a surface on which large and small dot regions are formed as light scattering dotted patterns, the small dot region being defined by an imaginary arch-like boundary line extending from a corner portion of the light guide member to another corner portion thereof and a side of the light guide member;
a reflective sheet provided on a back side of the light guide member;
a lamp provided at a side of the light guide member; and
a reflector to reflect light emitted from the lamp to the light guide member.

12. A light source device according to claim 11, wherein the small dot region is formed on a long side of the light guide member.

13. A light source device according to claim 11, wherein the small dot region is formed on a short side of the light guide member.

14. A light source device according to claim 11, wherein the lamp is a cold-cathode fluorescent tube.
